(19) United States
(12) Patent Application Publication
(10) Pub. No.: US 2019/0054507 A1
(43) Pub. Date: Feb. 21, 2019

(54) CLEANING APPARATUSES FOR CHECK VALVES

(71) Applicant: Mark Taylor, Medford, OR (US)

(72) Inventor: Mark Taylor, Medford, OR (US)

(21) Appl. No.: 16/129,524

(22) Filed: Sep. 12, 2018

Related U.S. Application Data
(63) Continuation-in-part of application No. 15/458,729, filed on Mar. 14, 2017, now abandoned.
Application No. 15/458,729 is a division of application No. 14/718,864, filed on May 21, 2015, now abandoned.

(51) Int. Cl. B08B 3/02; F16K 15/14; F16K 1/32; F16K 17/00; F16K 15/03

(52) U.S. Cl. CPC B08B 3/02; F16K 15/14; F16K 15/03; F16K 17/00; F16K 1/32

(57) ABSTRACT

A method, system, apparatus, and/or device for cleaning a check valve of a pressurized pipe system. The method, system, apparatus, and/or device may include a first check valve attached between pipes of a pressurized pipe system. The first check valve may include a housing, a disc attached to an interior cavity of the housing, a port formed in the housing, and a second check valve attached to the port. The disc may be configured to move between an open position to allow a first fluid to flow from a first pipe to a second pipe and a closed position to stop the first fluid from flowing from the second pipe to the first pipe. The second check valve may be configured to allow the second fluid to flow into the first check valve and stop the first fluid from flowing out of the second check valve.

### CROSS REFERENCE TO RELATED APPLICATIONS

This application is a continuation-in-part of application Ser. No. 15/458,729, filed 14 Mar. 2017, which is a divisional of application Ser. No. 14/718,864, filed 21 May 2015, which are hereby incorporated by reference for all purposes.

### BACKGROUND

Sewage, industrial effluent, and storm effluent can include debris, such as plastics, wire, branches, leaves, garbage, and so forth. In the case of sewage, debris may additionally include sanitary products, wipes, toilet paper, and so forth. Often drainage or channeling systems utilize check valves to prevent fluid backflow in the system. Debris may be wrap around or otherwise attach to or collect within the check valve and prevent full opening and/or full closure of the check valve.

### BRIEF DESCRIPTION OF THE DRAWINGS

FIG. 1A illustrates a pipe system with a first check valve and a cleaning apparatus, according to an embodiment.

FIG. 1B illustrates the first check valve in the open position, according to an embodiment.

FIG. 2 is a perspective view of the first check valve that includes the cleaning apparatus, according to an embodiment

FIG. 3 is a lateral cross-sectional view of the first check valve, according to an embodiment.

FIG. 4A illustrates a perspective view of the first check valve with pressurized material being projected towards the cleaning apparatus, according to an embodiment.

FIG. 4B illustrates a perspective view of the first check valve with fluid being sprayed into the interior of the first check valve via the cleaning apparatus, according to an embodiment.

FIG. 5A is a perspective view of the first check valve with pressured material be projected towards the cleaning apparatus as the first check valve is in an open position, according to an embodiment.

FIG. 5B illustrates a perspective view of the first check valve with fluid being sprayed into the interior of the first check valve via the cleaning apparatus with the first check valve in the open position, according to an embodiment.

FIG. 6 illustrates a perspective view of a peripheral cleaning device that may be used in combination with the port, according to an embodiment.

FIG. 7 illustrates a perspective view of the peripheral cleaning device attached to the rotation device, according to an embodiment.

### DETAILED DESCRIPTION

The disclosed check valves with in-situ cleaning apparatus and methods for cleaning check valves will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various check valves with in-situ cleaning apparatus and methods for cleaning check valves are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

Drainage systems, channeling systems, and fluid systems for sewage systems, industrial systems, and storm effluent may utilize check valves to prevent fluid backflow in the system. As debris flows through the systems, the debris may wrap around or otherwise attach to/collect within check valves and prevent full opening and/or full closure of the check valve. The debris may include plastics, wire, branches, leaves, garbage, sanitary products, wipes, toilet paper, and so forth. As the debris collect within check valves and prevent full opening and/or full closure of the check valve, the debris may cause backflow into the systems and/or prevent outflow through the check valves. Additionally, the systems may become hydraulically inefficient, thereby reducing the actual flow rate output.

Conventionally, to clean a check valve, the pipe system for the drainage system and channeling system may be opened and the debris may be removed from the check valve of the pipe system. Alternatively, to clean the debris from the check valve, the check valve may be removed from the pipe system, the check valve cleaned and serviced, and then reinstalled back into the pipe system. To open the system and/or remove and clean the check valve, the drainage system or channeling system must be shut down, which may be an expensive and time-consuming process. For example, in pipe systems, check valves are often sandwiched or disposed between tightly fitted mechanical devices, such as pump ends and knife gates. Additionally, voltages of up to 480 V commonly power bigger sewage pumps. These factors make dismantling and removal of blockages is time-consuming in conventional pipe systems. Further, the service operator may be exposed to potentially harmful fluid and/or debris contained in the pipe system. In addition, conventional check valve cleaning practices and mechanisms may be ineffective in removal of debris, lead to faster corrosion of the check valve, and/or lead to a failure to repair the hydraulic efficiency of the system.

Implementations of the disclosure address the above-mentioned deficiencies and other deficiencies by providing a method, system, device, and/or apparatus for cleaning the check valve of drainage systems and channeling systems. The method, system, device, or apparatus may utilize an in situ cleaning device that includes a pipe system with a first check valve and a cleaning apparatus. In one embodiment, the drainage system and channeling system may be a pressurized system. The first check valve may allow sewage, waste, fluids, fibrous material, fibrous waste, and other debris to outwardly flow in the system while stopping an inward flow or backflow into the system. The cleaning apparatus may include a nozzle with a second check valve that is approximate to the first check valve. The second check valve may allow fluid, such as water or a cleaning solution, to be sprayed into the pressurized system to clean the first check valve while allowing the pressurized system to continue operation.

One advantage of the cleaning apparatus may be to allow a user to clean the first check valve while keeping the pressurized drainage system or channeling system in operation and avoiding a temporary shutdown of the pressurized drainage system or channeling system as it is being cleaned. Another advantage of the cleaning apparatus may be to stop the outflow of the material in the pressurized system from back flowing out of the second check valve and exposing a user to caustic and dirty materials. Another advantage of the cleaning apparatus may be allowing the user to more quickly clean the drainage system or the channeling system at a greatly reduced risk of exposure to fluid and debris within the drainage system or the channeling system.

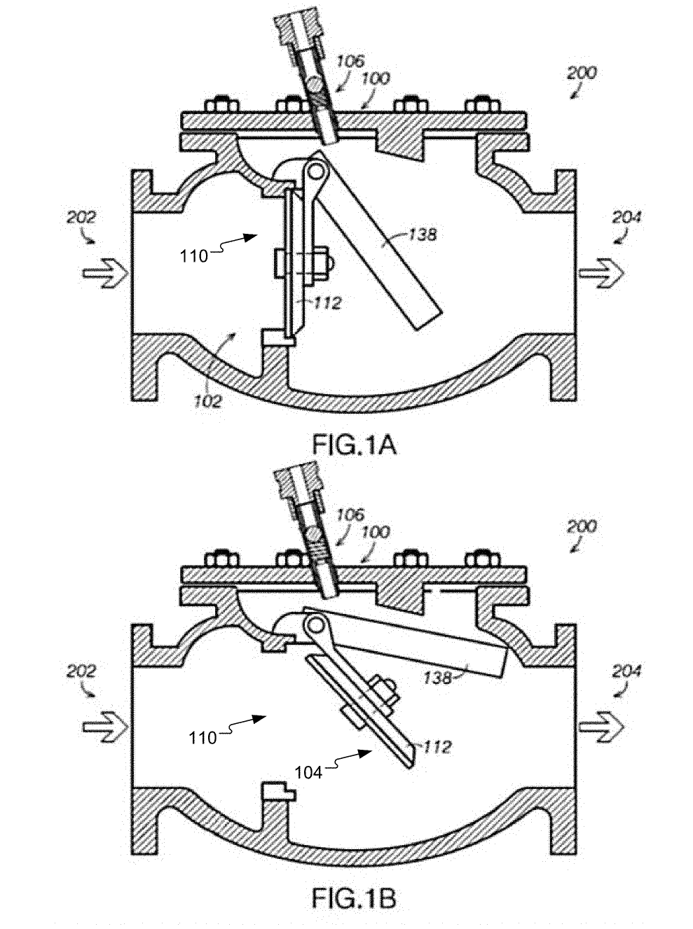

FIGS. 1A-5B illustrated a first valve 100 with an in situ cleaning apparatus 106. The first valve 100 may regulate hydraulic flow through a pipe system 200. The cleaning apparatus 106 may be used to clean, remove, and/or clear debris from the check valve components without removal of the first valve 100 and/or otherwise disrupting the operation of the pipe system 200. In one example, the first valve 100 may be used in combination with and/or is a component of a pump volute. The first valve 100 may be configured to clean the pump volute and/or an impeller housed inside of the pump volute.

FIG. 1A illustrates a pipe system 200 with a first valve 100 and a cleaning apparatus 106, according to an embodiment. In one embodiment, the first valve 100 and the cleaning apparatus 106 may be components of the pipe system 200. In one embodiment, the pipe system 200 may be part of a sewer system, a drainage system, a fluid system, and so forth. In another embodiment, the pipe system 200 may be a closed system. In another embodiment, the pipe system 200 may be a pressurized system_{[DM1]}. The pipe system 200 may attach to a first pipe at an upstream side 202 of the pipe system 200 that is upstream of the first valve 100. The pipe system 200 may also include second pipe at a downstream side 204 of the pipe system 200 that is downstream of the first valve 100. In one example, the first pipe may connect to an inlet of the pipe system 200 and the second pips may connect to an outlet of the pipe system 200.

In another embodiment, the first valve 100 may regulate a hydraulic flow of a material through pipe system 200. The material may include sewage, stormwater, industrial waste, and so forth. In one example, the first valve 100 may regulate hydraulic flow by allowing the flow of the material from the upstream side 202 portion of a housing of the first valve 100 to the downstream side 204 portion of the housing. The first check valve may also prevent a backflow of the material from the downstream side 204 of the housing to the upstream side 202 of the housing.

To allow the outflow of the material and prevent the backflow of the material, the first valve may include a disc 112 that covers an opening 110 of the first valve 100 that the material may flow through. In one embodiment, the disc 112 may be hingedly attached to a body of the first valve 100. The disc 112 may switch between a closed position 102 (as shown in FIG. 1A) and an open position 104 (as shown in FIG. 1B).

In one example, when pressure from the pipe system 200 on the upstream side 202 is below a threshold, the first valve 100 may remain in a closed position 102. In another example, when pressure from the pipe system 200 is greater on the downstream side 204 than the upstream side 202, the first valve 100 may remain in the substantially closed position 102.

In another embodiment, the first valve 100 may be a wafer spring resilient check valve or a swing check valve that includes a spring mechanism to bias the first valve 100 towards the closed position. In another embodiment, the first valve 100 may be a potable water gate valve or another type of check valve. In another embodiment, the first valve 100 is used in combination with and/or is a component of a pump volute. The first valve 100 may be configured to clean the pump volute and/or an impeller housed inside of the pump volute.

The material moving through the pipe system 200 may include debris that may collect on downstream side 204 proximal to first valve 100. The debris may prevent the first valve 100 from fully opening and/or closing. The debris may include plastics, wire, branches, leaves, garbage, sanitary products, wipes, toilet paper, and so forth. To remove the debris from the first valve 100, the pipe system 200 may include an in-situ cleaning apparatus 106.

The in-situ cleaning apparatus 106 is a cleaning system that may be used in line with the pipe system 200 and the first valve 100. As discussed above, the pipe system 200 may be part of a pressurized system that is a conduit for caustic and dirty materials. When the debris gets caught on the first valve 100, the cleaning apparatus 106 may be used to clean the first valve 100 as the material flows through the pipe system 200 without disrupting the operation of the pipe system 200. As discussed above, the first valve 100 may be used in combination with and/or is a component of a pump volute, and the first valve 100 may be configured to clear debris and clean the pump volute and/or an impeller housed inside of the pump volute.

As discussed below, the cleaning apparatus 106 may include a handle 138 that is connected to a disc 112 of the first valve 100. The handle 138 may be configured to be grasped by a user for manual movement of disc 112 between the closed position 102 and the open position 104. In one example, the handle 138 may be automatically operated via a robotic system and/or a hydraulic system.

FIG. 1B illustrates the first valve 100 in the open position 104, according to an embodiment. Some of the features in FIG. 1B are the same or similar to some of the features in FIG. 1A as noted by same reference numbers, unless expressly described otherwise. In one embodiment, when the pressure in the pipe system 200 on the upstream side 202 is above a threshold amount, the first valve 100 may move into an open position 104. In another embodiment, when the pressure in the pipe system 200 is greater on the upstream side 202 than the downstream side 204, the first valve 100 may move into the open position 104. The degree that the first valve 100 may be opened in the open position may vary based on an amount of pressure in the pipe system 200. For example, the first valve 100 may be open 1 degree (slightly open) to 90 degrees (fully open) relative to the pipe system 200 in the open position. Accordingly, the degree of opening of the check valve can vary between slightly open to fully open.

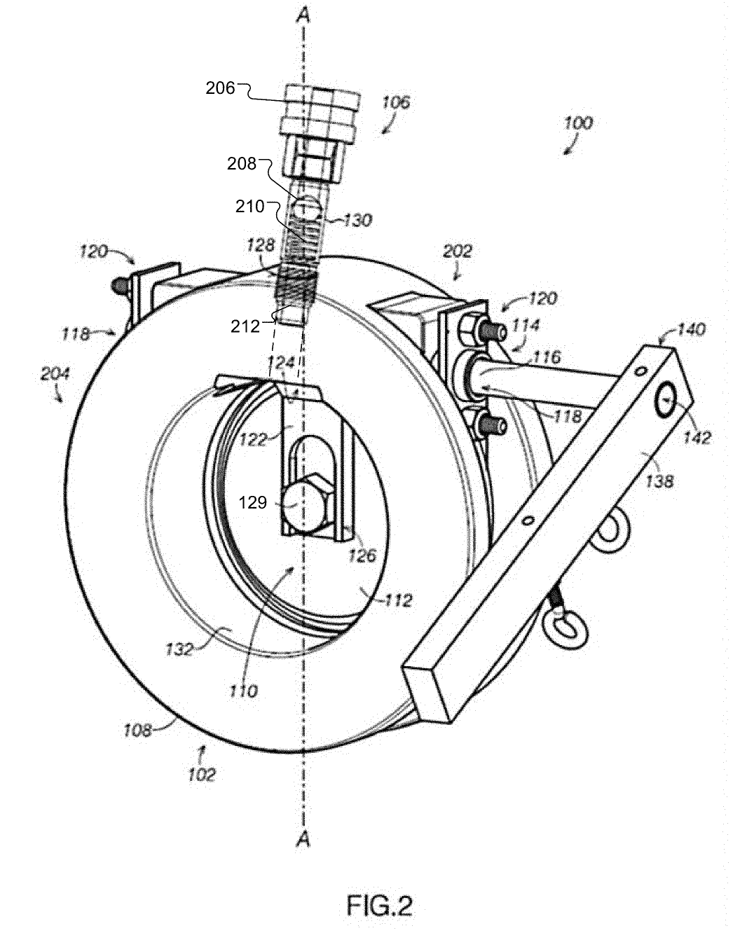

FIG. 2 is a perspective view of the first valve 100 that includes the cleaning apparatus 106, according to an embodiment. Some of the features in FIG. 2 are the same or similar to some of the features in FIG. 1A-B as noted by same reference numbers, unless expressly described otherwise. In one embodiment, the first valve 100 may include the cleaning apparatus 106, a curved side wall 108, the opening 110 substantially encompassed by the side wall 108, a disc 112, and a nozzle 130. In one embodiment, the curved side wall 108 may include a valve seat for the first valve 100. In another embodiment, the opening 110 may include an annular area of the first valve 100.

As discussed above, the disc 112 may be disposed within opening 110 and be moveable or pivotable between the closed position 102 in FIG. 1A and the open position 104 in FIGS. 1B. In one example, the disc 112 substantially blocks opening 110 in the closed position 102. In another example, the disc 112 may unblock the opening 110 in open position 104.

In one embodiment, at least a portion of the disc 112 may be connected to the side wall 108 via a hinge 114. The hinge 114 may include a rod 116 rotatable within a laterally extended hole 118 in the side wall 108 and attached to the side wall 108 via an attachment 120. The hinge 114 may include an arm 122 for coupling the disc 112 to the rod 116. For example, the arm 122 may be fixedly coupled to the rod 116 at a first end 124 and fixedly coupled to a center of the disc 112 at a second end 126. In another example, the arm 122 may be a plate that makes surface-to-surface contact with disc 112. The arm 122 may be coupled to the disc 112 via a fastening member 129 inserted through aligned holes in the disc 112 and the arm 122. In another example, the first end 124 may include a tightenable sleeve for receiving and retaining the rod 116. The above example of the first valve 100 is not intended to be limiting. The first valve 100 may have different configurations to pivotably attach the disc 112 to the side wall 108.

The first valve 100 may include a port 128 in the side wall 108. The port 128 may be a conduit or channel that extend from an exterior surface of the first valve 100 to an inner surface of the first valve 100 In one embodiment, the port 128 may be disposed in the side wall 108 proximal to the hinge 114. For example, the port 128 may be on a top side of the first valve 100. In another example, the port 128 may be located at a bottom of the first valve 100, a first side of the first valve 100, a second side of the first valve 100, and so forth. Further, the cleaning apparatus 106 may include multiple ports 128 at different locations along the side wall 108. The port 128 may be located on the upstream side or the downstream side of the first valve 100.

The port 128 is configured to receive or couple to a nozzle 130. The nozzle 130 may be coupled to a fluid source for spraying fluid from the fluid source onto an inner surface 132 of side wall 108 and/or the downstream side 204 of disc 112 in order to clear debris from first valve 100.

In one embodiment, the nozzle 130 may include a valve. For example, the nozzle 130 may be a second check valve, a clack valve, a non-return valve, a reflux valve, a retention valve, a one-way valve, and so forth. In one example, the nozzle 130 may be a one-way ball valve, such as a one-way ball check valve. The one-way ball check valve may allow fluid from the fluid source to be sprayed onto an inner surface 132 of the side wall 108 and/or the downstream side 204 of disc 112 while stopping material, such as liquid or debris, from flowing out of the first valve 100 or the pipe system 200 in FIGS. 1A and 1B through the nozzle 130. The nozzle 130 may include a fastener 206, a blocker 208, an elevator 210, and an opening 212.

The fastener 206 may be a located at a top of the cleaning apparatus 106 that faces the outside or exterior of the first valve 100. The fastener 206 may be configured to connect to an end of a conduit that provides the fluid from the fluid source. In one example, the conduit may be a pipe, a hose, a tube, and so forth. In one example, the fastener 206 may be a quick connect fastener to quick connect to an end of the conduit. In another example, the fastener 206 may be a threaded fastener, a locking fastener, and so forth to connect to an end of the conduit.

In one embodiment, a portion of the nozzle 130 may be affixed to the port 128. In one example, the nozzle 130 and the port 128 may connect to form a seal such that fluids and other materials may only enter the port 128 via the nozzle 130. The nozzle 130 may include a conduit extending from the fastener 206 to the opening 212. In one embodiment, the conduit may be an unobstructed path for the fluid to enter the interior of the first valve 100.

The elevator 210 may be configured to elevate and depress in order to place the blocker 208 in an open position and a closed position. In one embodiment, when the blocker 208 is in the closed position, the elevator 210 may be elevated to press the blocker 208 upward to form a seal with the conduit of the nozzle 130 to block fluid or other materials from flowing into the first valve 100. In another embodiment, when the blocker 208 is in the open position, the elevator 210 may be depressed downward to break the seal between the blocker 208 and the conduit to allow the fluid or other material to flow into the first valve 100 from the fluid source connected to the fastener 206. The blocker 208 may be a ball, a disk, a plate, and so forth. The elevator 210 may be a spring, a coil, a mechanical actuator, and so forth. The blocker 208 and/or the elevator 210 may be a metal material, a plastic material, a rubber material, a glass material, and so forth. For example, the blocker 208 may be a ball and the elevator 210 may be a spring. The ball may rest on top of the spring.

As discussed above, the cleaning apparatus 106 is an in situ cleaning apparatus that it is capable of cleaning the first valve 100 without removal of the first valve 100, the opening of the pipe system 200 in FIGS. 1A-B, and/or shutting down of the pipe system 200 in FIGS. 1A-B. As discussed above, the pipe system 200 may be a pressurized system in order to move material through a sewage system, an industrial system, a storm effluent, and so forth. Where the pipe system 200 is pressurized, the first valve 100 may not be accessed with a hole or duct from the exterior of the first valve 100 to the interior of the first valve 100 because the hole or duct would depressurize the pipe system 200. Additional, the hole or duct would spew the material (such as sewage) from the interior of the first valve 100 on to the user because the pressure from the pipe system 200 would force the material out of the hole or duct onto the user and/or the surrounding area. Accordingly, the cleaning apparatus 106 with the nozzle 103 that include the blocker 208 and the elevator 210 to restrict the pressurized material from exiting the first valve 100 while allowing fluid to be sprayed into the interior of the first valve 100 may allow the disc 112 and/or other parts of the first valve 100 to be cleaned while the pipe system 200 remains pressurized.

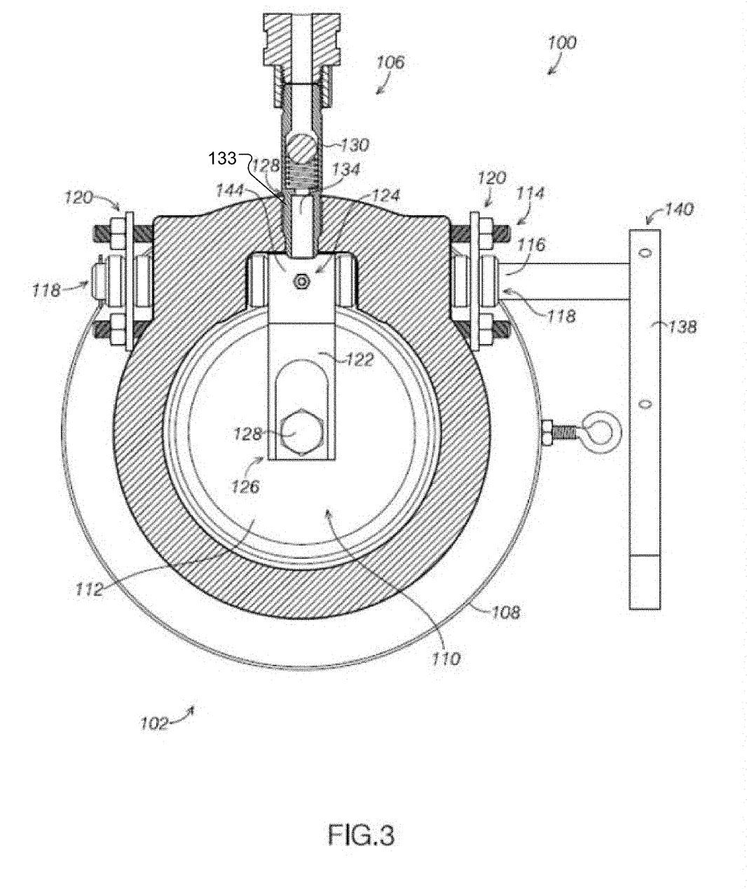

FIG. 3 is a lateral cross-sectional view of the first valve 100, according to an embodiment. Some of the features in FIG. 3 are the same or similar to some of the features in FIGS. 1A-B and 2 as noted by same reference numbers, unless expressly described otherwise. In one embodiment, the port 128 may be a quick-connect access port configured to be releasably coupled to the nozzle 130 for high-pressure spraying of fluid (e.g., spraying of fluid between 1,750 psi and 5,000 psi). For example, the nozzle 130 may be directly and threadably attachable to port 128 via a threaded section 133 of the nozzle 130 and a complementarily configured threaded section 134 of the port 128. In another embodiment, the nozzle 130 may be releasably attachable to the port 128 via a slide fit of the nozzle 130 through a flexible gasket in the port. In another embodiment, the nozzle 130 may be fixedly attached to the port 128, such as the nozzle 130 being welded to the port 128 and/or a sealant being applied to an annular seam between the port 128 and the nozzle 130. The nozzle 130 may spray a fluid, such as water, a cleaning fluid, a cleaning agent, and so forth.

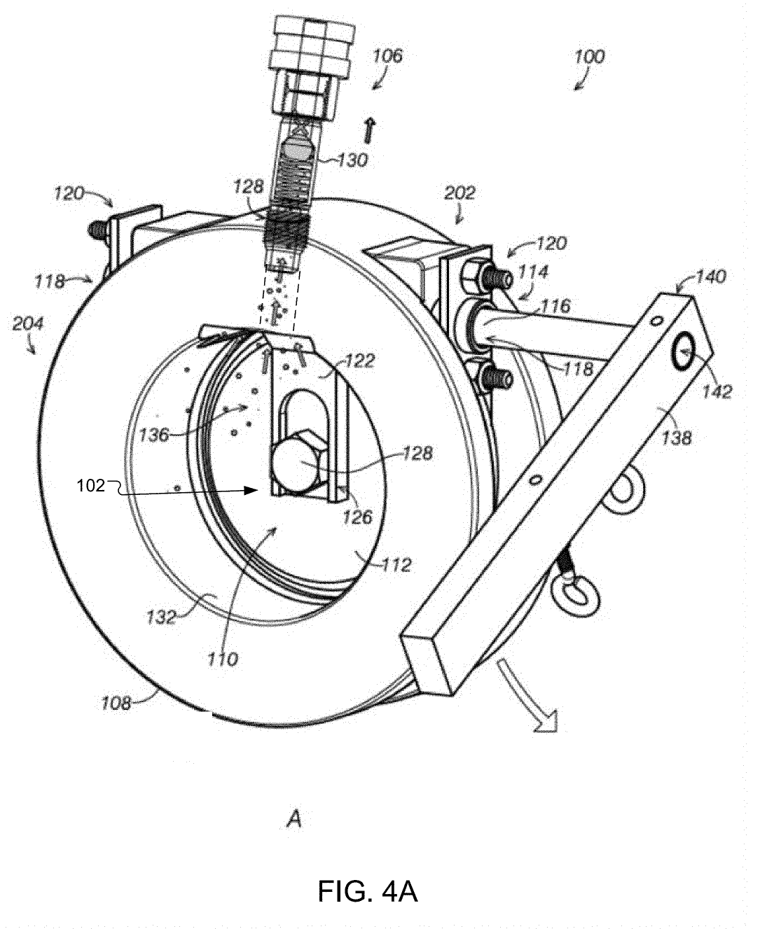

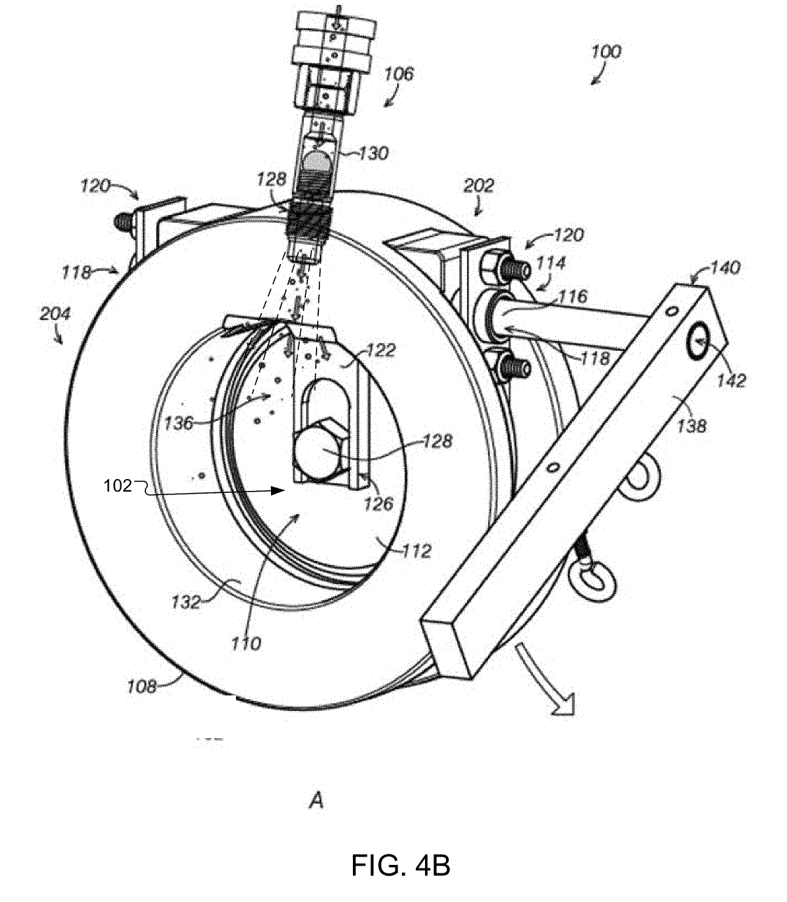

FIG. 4A illustrates a perspective view of the first valve 100 with pressurized material being projected towards the cleaning apparatus 106, according to an embodiment. Some of the features in FIG. 4A are the same or similar to some of the features in FIG. 1A-3 as noted by same reference numbers, unless expressly described otherwise. FIG. 4A illustrates the first valve 100 in a closed position, where the handle 138 is rotated downward and counterclockwise to pivot the disc 122 into the closed position.

As discussed above the first valve 100 may be part of a pressurized system, where fluid may flow through the first valve 100. When the cleaning apparatus 106 is attached to the first valve 100, the cleaning apparatus 106 may be a one-way valve that may not allow the pressurized fluid in the first check valve or attached pipes to flow out of the cleaning apparatus 106. When the pressurized fluid is projected toward the cleaning apparatus 106, the one-way valve of the cleaning apparatus 106 may close to keep the fluid within the interior of the first valve 100 and the pressurized system.

FIG. 4B illustrates a perspective view of the first valve 100 with fluid being sprayed into the interior of the first valve 100 via the cleaning apparatus 106, according to an embodiment. Some of the features in FIG. 4B are the same or similar to some of the features in FIG. 1A-4A as noted by same reference numbers, unless expressly described otherwise. As discussed above, a conduit of a fluid source may be attached to the cleaning apparatus 106 such that fluid may be sprayed into the interior of the first valve 100 to remove debris from the disk 122 or other parts of the first valve 100. In one embodiment, the cleaning apparatus 106 may spray the fluid into the interior of the first valve 100 in a defined spray pattern 136. The spray pattern 136 may be a narrower fan pattern, a wider fan pattern, a cone pattern, a jet or point pattern, and so forth. In another embodiment, the spray pattern 125 may be spraying a fluid at a 67 degree angle from a vertical plane of the first valve 100. In another embodiment, the spray pattern 125 may be a vertically aligned fan pattern. In another embodiment, the cleaning apparatus 106 may spray the fluid into the interior of the first valve 100 in a random or undefined pattern.

In another embodiment, the cleaning apparatus 106 or a part of the cleaning apparatus 106, such as the nozzle, may be rotated to spray liquid in a variety of orientations. In another embodiment, the nozzle 130 may be one of a variety of interchangeable nozzles configured to releasably couple with the port 128 and spray liquid in different patterns.

In another embodiment, the handle 138 may be connected at a distal end 140 of a rod 116. For example, the distal end 140 may be inserted into and retained in a receiving hole 142 of the handle 138. In another example, the distal end 140 may be fixed within receiving hole 142. In another example, the handle 138 may be attached to the rod 116 by welding, attachment members inserted through aligned holes in the handle 138 and the rod 116, and so forth. In another example, the handle 138 may be releasably attachable to the rod 116 so that the handle 138 may be removed when not in use.

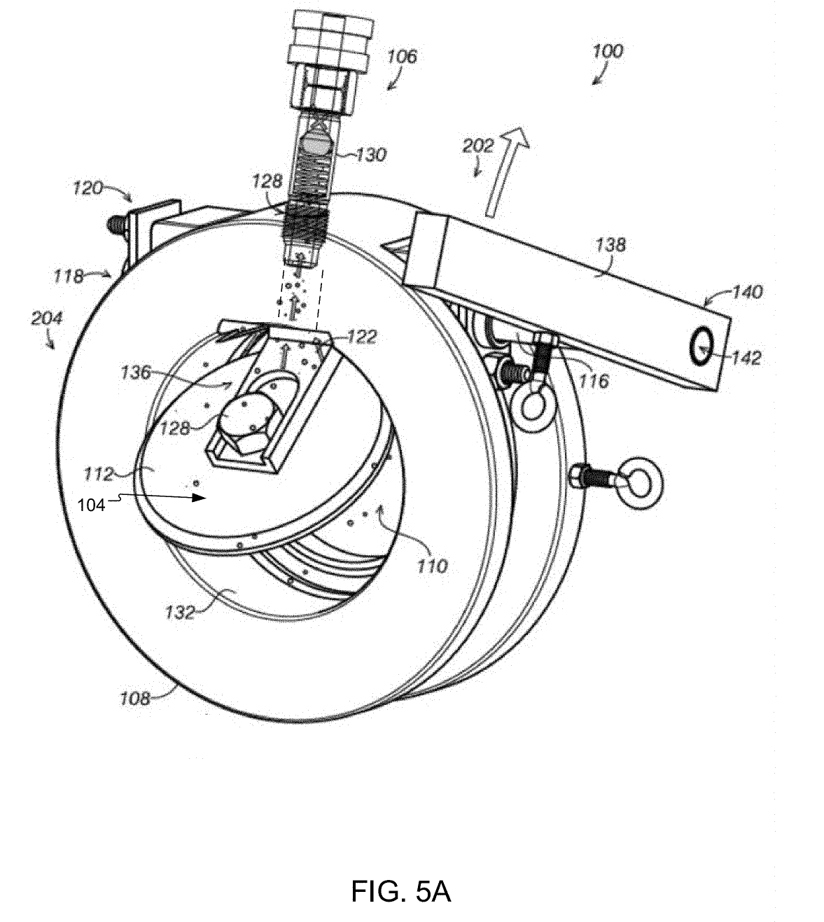

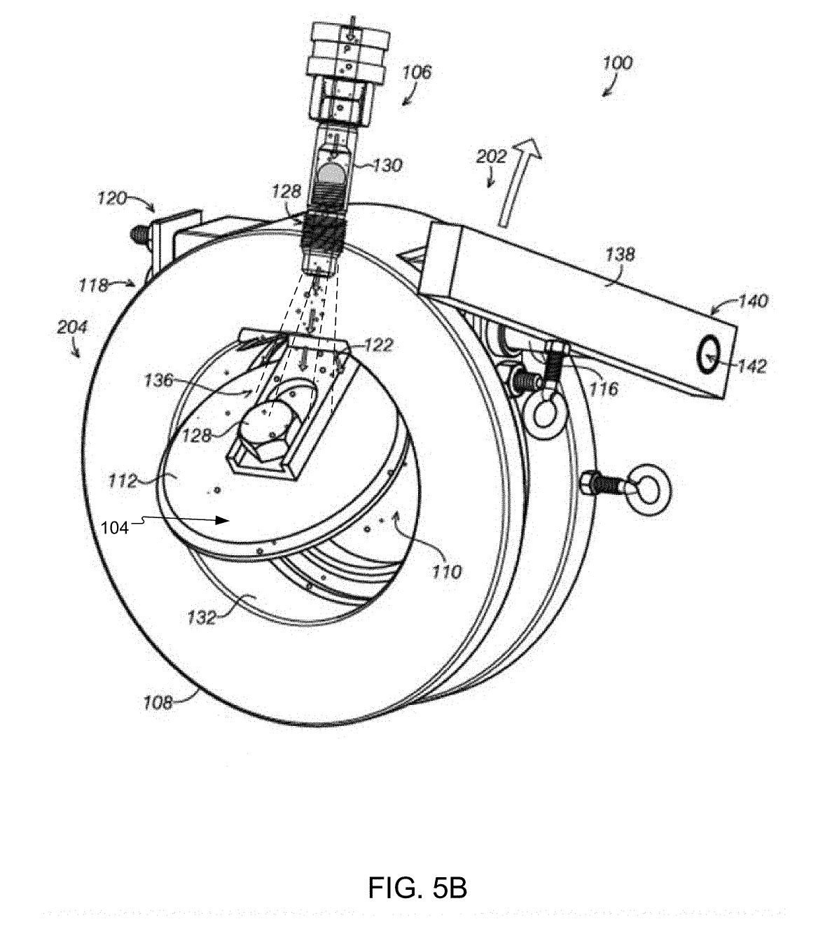

FIG. 5A is a perspective view of the first valve 100 with pressured material be projected towards the cleaning apparatus 106 as the first valve 100 is in an open position, according to an embodiment. Some of the features in FIG. 5A are the same or similar to some of the features in FIG. 1A-4B as noted by same reference numbers, unless expressly described otherwise. FIG. 5A illustrates the first valve 100 in an opened closed position, where the handle 138 is rotated upward and clockwise to pivot the disc 122 into the open position. As discussed above, the handle 138 may be operated to manually open and close the disc 112 during the operation of the first valve 100 and/or during the spraying of fluid through nozzle 130. In one embodiment, the movement of the disc may assist in removal, loosening, and/or clearing of debris from the first valve 100, such as the disc 112. As discussed above the first valve 100 may be part of a pressurized system, where fluid may flow through the first valve 100. When the cleaning apparatus 106 is attached to the first valve 100, the cleaning apparatus 106 may be a one-way valve that may not allow the pressurized fluid in the first check valve or attached pipes to flow out of the cleaning apparatus 106. When the pressurized fluid is projected toward the cleaning apparatus 106, regardless of whether the first valve 100 is in the open position or the closed position, the one-way valve of the cleaning apparatus 106 may close to keep the fluid within the interior of the first valve 100 and the pressurized system.

FIG. 5B illustrates a perspective view of the first valve 100 with fluid being sprayed into the interior of the first valve 100 via the cleaning apparatus 106 with the first valve 100 in the open position, according to an embodiment. Some of the features in FIG. 5B are the same or similar to some of the features in FIG. 1A-5A as noted by same reference numbers, unless expressly described otherwise. In one embodiment, the handle 138 may be rotated upward and clockwise movement to move the disc 112 into the open position. In another embodiment, the handle 138 may be rotated upward and counterclockwise movement to move the disc 112 into the open position. The clockwise movement of the handle 138 may pivot the disc 112 into the closed position and counterclockwise movement may pivot the disc 112 into the open position, or vice versa.

The movement of the disc 112 into the open position 104 may increase an impact of the fluid on the surface of the disc 112. In one embodiment, the handle may be operated to swivel or rotate the disc 112 multiple times to aid in removing the debris from the first valve 100. In another embodiment, the handle may be operated separately or in combination with spray from the nozzle 130 to remove the debris from the disc 112 and/or other parts of the first check valve and/or connected pipes. In one example, as the fluid from the cleaning apparatus 106 hit the disc 112 and/or other parts of the first valve 100, the sound of the fluid impact may indicate whether the debris has been cleared. In another example, the fluid from the cleaning apparatus 106 may be sprayed at a relatively low pressure, such as below 100 pounds per square inch (PSI). In another example, the fluid from the cleaning apparatus 106 may be sprayed at a relatively high pressure, such as above 100 PSI._{[DM2]} The low pressure or high-pressure spraying of the fluid onto inner surface 132 of side wall 108 and/or a downstream side of disc 112 may remove, loosen, and/or clear debris that may be trapped in first valve 100.

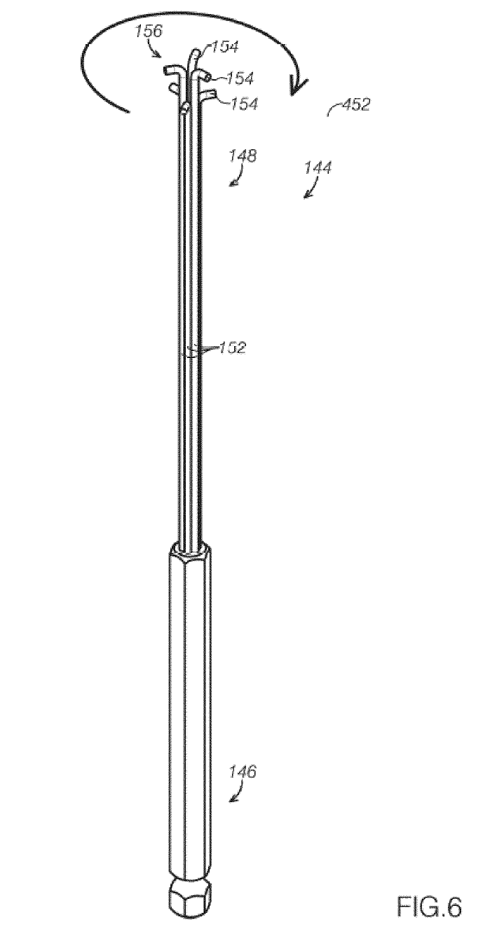

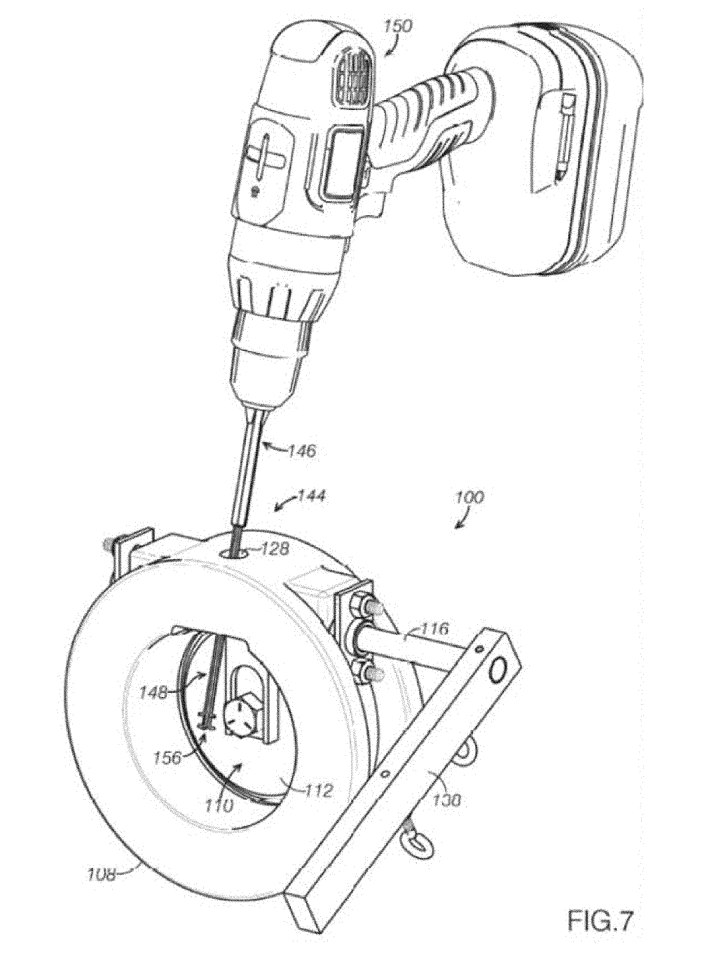

FIG. 6 illustrates a perspective view of a peripheral cleaning device 144 that may be used in combination with the port 128, according to an embodiment. Some of the features in FIG. 6 are the same or similar to some of the features in FIG. 1A-5B as noted by same reference numbers, unless expressly described otherwise. In one embodiment, the peripheral cleaning device 144 may be an elongate member having a first end 146 attachable to a rotation device 150 (as shown in FIG. 7) and a second opposing end 148 that is insertable through port 128. In one example, the peripheral cleaning device 144 may be insertable through the port 128 when the nozzle 130 is removed/uncoupled from the port 128.

In one embodiment, the first end 146 may include one or more flat faces 146 for attachment to the rotation mechanism 150. The insertable second end 148 may include one or more wires 152. In one example, the wires 152 may be free and/or unattached to each other. In another example, the wires 152 may be attached to each other, such as being welded, adhered, and so forth to each other. In another example, the wires 152 may be spring type wires that may be at least partially flex outwardly when rotated at a high speed. In another example, the wires 152 may be rigid wires.

In another example, a distal tip of second end 148 may include a barbed tip 156. The barbed tip 156 may be formed by outwardly bent tip end portions of wires 152. In another example, the second end 148 may be a single rigid member with an attached barbed tip. In another example, the barbed tip may be releasable or fixed attached to the second end 148. In another example, the barbed tip may different wires with various widths and/or lengths and the wires may be bent to form barbs at any desired point along the wire.

FIG. 7 illustrates a perspective view of the peripheral cleaning device 144 attached to the rotation device 150, according to an embodiment. Some of the features in FIG. 7 are the same or similar to some of the features in FIG. 1A-6 as noted by same reference numbers, unless expressly described otherwise. As discussed above, the peripheral cleaning device 144 may be inserted through port 128 into an interior portion of the first valve 100

When the peripheral cleaning device 144 is inserted through port 128, the peripheral cleaning device 144 may be movable up and down by the user moving rotation device 150 with an alternating upward and downward movement. In one embodiment, the rotation device 150 may be a drill, a handle, a wrench, and so forth.

In one example, the second end 148 and barbed tip 156 of the peripheral cleaning device 144 may be moveable within the opening 110. In another example, the second end 148 and the barbed tip 156 may be rotatable within the opening 110 via a rotational movement driven by rotation device 150. In another example, a movement (such as an up and down movement, a rotation, and so forth) of the peripheral cleaning device 144 within the opening 110 may aid in dislodging, ejecting, and cleaning of debris from the opening 110 and/or the disc 112 by entangling various debris onto the barb tips 156. In another example, the peripheral cleaning device 144 may be used in conjunction or separate from the nozzle 130 in FIGS. 1A-5B to clear the blockage from the first valve 100 and/or the pump volute.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A system, comprising:
a pressurized pipe system, the pressurized pipe system being is a closed system comprising:
a first pipe connected to a fluid system; and
a second pipe connected to an outlet, wherein the first pipe and the second pipe are configured to conduct a first fluid with fibrous material suspended therein;
a first check valve connecting the first pipe to the second pipe, wherein the first check valve comprises:
a housing;
a disc hingedly attached to an interior cavity of the housing, wherein the disc is configured to move between an open position to allow the first fluid to flow from the first pipe to the second pipe and a closed position to stop the first fluid from flowing from the second pipe to the first pipe; and
a port formed in the housing; and
a cleaning apparatus configured to attach to the port, the cleaning apparatus comprising:
a fastener configured to connect to a conduit of a second fluid;
a second check valve connected to the fastener, the second check valve configured to allow the second fluid to flow into the first check valve and stop the first fluid from flowing out of the fastener; and
a nozzle disposed in the port, wherein the nozzle is configured to direct the second fluid into an interior portion of the first check valve.

2. The system of claim 1, wherein the nozzle is configured to spray the second fluid toward the disc to remove debris from the first fluid caught on the disc.

3. The system of claim 1, further comprising a handle operatively coupled to the disc, wherein the handle is configured to raise the disc toward the nozzle.

4. The system of claim 1, wherein the fastener is configured to receive the second fluid at a pressure between 1750 pounds per square inch (PSI) and 5,000 PSI.

5. The system of claim 1, wherein the second fluid is a cleaning agent to clean the first check valve.

6. The system of claim 1, wherein the first check valve is a wafer spring resilient check valve.

7. The system of claim 1, wherein the first check valve is a one-way valve.

8. The system of claim 1, wherein the second check valve is a one-way valve.

9. The system of claim 1, wherein the fastener is a first quick connect fastener configured to connect to a second quick connect fastener of the conduit.

10. The system of claim 1, wherein the cleaning apparatus is an in-situ device configured to operate at the same time as the first check valve while the pressurized pipe system is pressurized.

11. The system of claim 1, wherein the port is formed in the housing downstream of the disc.

12. The system of claim 1, wherein the nozzle is fixedly attached to the port.

13. The system of claim 1, wherein the cleaning apparatus is fixedly attached to the port.

14. An apparatus, comprising,
a first check valve configured to attach between a first pipe and a second pipe of a pressurized pipe system, wherein the first check valve comprises:
a housing;
a disc attached to an interior cavity of the housing, wherein the disc is configured to move between an open position to allow a first fluid to flow from the first pipe to the second pipe and a closed position to stop the first fluid from flowing from the second pipe to the first pipe; and
a port formed in the housing; and
a second check valve configured to attach to the port, a cleaning apparatus configured to attach to a conduit with a second fluid, wherein the second check valve configured to allow the second fluid to flow into the first check valve and stop the first fluid from flowing out of the second check valve.

15. The apparatus of claim 14, wherein the first fluid comprises fibrous material suspended therein, wherein the fibrous material comprises at least one of a sanitary product, toilet paper, or a wipe.

16. The apparatus of claim 14, wherein the first check valve is a first one-way valve and the second check valve is a second one-way valve.

17. A device, comprising,
a first valve configured to receive a first fluid from a first source, wherein the first valve comprises:
a housing;
a disc attached to an interior cavity of the housing, wherein the disc is configured to move between an open position to allow the first fluid to flow through the interior cavity and a closed position to stop the first fluid from flowing through the interior cavity; and
a port formed in the housing; and
a second valve configured to attach to the port, the second valve configured to receive a second fluid from a second fluid source, wherein the second valve configured to allow the second fluid to flow into the first valve and stop the first fluid from flowing out of the second valve.

18. The device of claim 17, wherein the first valve receive the first fluid at a first high pressure and the second valve receives the second fluid at a second high pressure.

19. The device of claim 17, wherein the first valve is a first one-way valve and the second valve is a second one-way valve.

20. The device of claim 17, wherein the first valve is a first check valve and the second valve is a second check valve.
